(19) United States
(12) Patent Application Publication
(10) Pub. No.: US 2025/0306855 A1
(43) Pub. Date: Oct. 2, 2025

(54) MULTIPLY-AND-ACCUMULATE BLOCKS FOR EFFICIENT PROCESSING OF OUTLIERS IN NEURAL NETWORKS

(71) Applicant: QUALCOMM Incorporated, San Diego, CA (US)

(72) Inventor: Mahdi NAZM BOJNORDI, San Diego, CA (US)

(21) Appl. No.: 18/623,907

(22) Filed: Apr. 1, 2024

(51) Int. Cl. G06F 7/544; G06F 5/01; G06F 7/50; G06F 7/523

(52) U.S. Cl. CPC G06F 7/5443; G06F 5/01; G06F 7/50; G06F 7/523

(57) ABSTRACT

Certain aspects of the present disclosure provide techniques and apparatus for efficiently performing operations using a machine learning model. The method generally includes receiving an input into a machine learning model, the input including a plurality of channels, each respective channel being associated with a respective scaling factor. Data associated with a first channel of the plurality of channels is scaled based on a binary shift associated with a scaling factor associated with the first channel. An output of a layer in the machine learning model is generated based on the first channel of the plurality of channels for the input and the scaling factor associated with the first channel. An inference is generated based at least on the output of the layer of the machine learning model.

### INTRODUCTION

Aspects of the present disclosure relate to machine learning.

Machine learning is generally the process of producing a trained model (e.g., an artificial neural network, a tree, or other structures), which represents a generalized fit to a set of training data. Applying the trained model to input data produces inferences, which may be used to gain insights into the input data. In some cases, applying the model to the input data is described as “running an inference” or “performing an inference” on the input data.

To train a model and perform inferences on input data, various mathematical operations are performed using various mathematical processing components. For example, multiply-and-accumulate (MAC) units may be used to perform these operations to train a model and perform inferences on input data using the trained model. It should be noted, however, that MAC units may be used for various mathematical operations and are not so limited to use in mathematical operations related to training a model and performing inferences on input data. These mathematical operations may be performed on various types of numerical data with varying complexity. Generally, the complexity of these operations may scale with the bit size of the data and the type of the data. For example, operations using 8-bit integers may be less computationally complex than performing an inference using larger sized integers, such as 64-bit integers. Similarly, operations using a given bit size of integers may be less computationally complex than operations using the given bit size of floating point numbers (e.g., operations performed using 32-bit integers may be less computationally complex than operations using 32-bit floating point numbers, even though the data is the same size in bits).

Power utilization, thermal output, and processing time generally scale with computational complexity. That is, less computationally complex operations generally consume less power and are completed more quickly than more computationally complex operations. Consequently, the execution of more computationally complex operations may result in reduced battery life and delays in the ability to reassign computing resources (e.g., compute cores on a processor, memory, etc.) to other tasks executing on a device.

### BRIEF SUMMARY

Certain aspects provide a processor-implemented method for efficiently performing operations using a machine learning model. The method generally includes receiving an input into a machine learning model, the input including a plurality of channels, each respective channel being associated with a respective scaling factor. Data associated with a first channel of the plurality of channels is scaled based on a binary shift associated with a scaling factor associated with the first channel. An output of a layer in the machine learning model is generated based on the first channel of the plurality of channels for the input and the scaling factor associated with the first channel. An inference is generated based at least on the output of the layer of the machine learning model.

Certain aspects provide a multiply-and-accumulate (MAC) unit for efficient processing of inputs in a machine learning model. The MAC unit generally includes a multiplier configured to generate a product of a weight input and an activation input associated with a channel of an input into the machine learning model; one or more shifters configured to generated a scaled accumulator value based on applying a binary shift to accumulator data based on a binary shift associated with a scaling factor defined for the channel; an adder configured to generate a sum of the product of the weight input and the activation input associated with the channel and the scaled accumulator value; and an accumulator configured to store, as the accumulator data, the sum of the product of the weight input and the activation input associated with the channel and the scaled accumulator value.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates an example organization of data channels associated with an input into a machine learning model based on maximum outlier values associated with each channel in the input into machine learning model, according to aspects of the present disclosure.

FIGS. 2A and 2B illustrate an example multiply-and-accumulate (MAC) block for efficiently processing inputs in a machine learning model, according to aspects of the present disclosure.

FIG. 3 illustrates example operations for efficiently processing inputs in a machine learning model based on binary shifts associated with outlier magnitude for channels associated with an input into a machine learning model, according to aspects of the present disclosure.

FIG. 4 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for efficiently processing inputs into a machine learning model using multiply-and-accumulate (MAC) units.

Generally, neural networks perform inferences based on input data, weights, and activations that may be defined in various types of data. The types of data that a neural network can use to perform inferences may vary in type (e.g., integer or floating point) and in bit size (also referred to as bit width). The computational complexity involved in performing inferences using a neural network may depend on the type and bit size of the data used. For example, integer operations may be less computationally complex than floating point operations due to the manner in which floating point numbers are defined. Further, operations using data having smaller bit sizes may be less computationally complex than operations using data having larger bit sizes. Computational complexity may be a significant limiting factor on the use cases and types of devices that can perform machine learning processing.

Machine learning models, such as transformer neural networks, generally learn and classify data based on significant outliers. Because these machine learning models learn significant outliers, machine learning models generally use large and/or complex data types for data within the transformer neural networks, such as 16-bit integers, or varying sizes of floating-point numbers (e.g., 8-bit floating point, 16-bit floating point, etc.), to accommodate the large dynamic range of valid data within the transformer neural network. The generation of these significant outliers within a transformer neural network generally is a self-perpetuating event, as linear units within a neural network (e.g., softmax linear units or the like) may generate a gradient signal that causes the transformer neural network to learn to generate ever further outliers, because these linear units generally do not generate a value of 0 unless the input is a value of −∞. Because −∞ is a theoretical value which inputs into a linear unit of a neural network may approach −∞ but may not equal, linear units generally do not output a value of 0 for any input into these linear units (but output values ever closer to 0 as the input approaches −∞).

For example, in a natural language processing application, transformer neural networks may include attention heads that allocate a significant number of attention probabilities to separator tokens (e.g., non-word tokens, such as those corresponding to a space character, periods, commas, the “[September]” token (or other separator token) representing a delimiter between different sentences, etc.). These transformer neural networks generally learn to have small values for these separator tokens, and thus, in training, the neural network attempts to either bypass updating residual layers within the neural network or partially updates the residual layers in the neural network. To achieve attention probabilities close to zero for non-separator tokens, the inputs into linear units (e.g., a softmax linear unit) generally have a large dynamic range. Normalization techniques generally soften outliers, and thus, in order to affect the output of a neural network, outliers generally are large absolute values (e.g., relative to other statistical measures). For example, an outlier may be defined as a value that is more than a defined number of standard deviations away from the mean of an activation tensor or a value whose absolute value exceeds a threshold value. As discussed, significant outliers generally cause a neural network to learn to generate ever further outliers, which may thus increase the computational complexity involved in processing data using transformer neural networks (e.g., as these neural networks may quantize data into bins defined by large, complex data types that are computationally expensive to process).

Various techniques can be used to reduce the power utilization of multiply-and-accumulate (MAC) units. In some cases, the size of the data processed in a neural network may be reduced. For example, data may be scaled to a smaller range, rounded, quantized into one of a plurality of “bins,” or the like. For example, to quantize floating-point data, a floating point number r may be quantized to an integer q using a scaling factor S and a zero point Z, according to the equation:

$$r = S ( q - Z ) ,$$

$$where$$

$$q = round ( \frac{r}{S} ) + Z .$$

Z may be set to 0 for symmetric quantization or some other value for asymmetric quantization. Given a number b of bits for quantization, q may be in the range of [−2^{b-1}, 2^{b-1}−1]. The scaling factor may be calculated on a per-input-channel basis and may be represented by the equation:

$$S = \frac{max \{ \vert {r}_{min} \vert , \vert {r}_{max} \vert \}}{{2}^{b - 1} - 1} .$$

Quantization techniques may result in a loss of precision and thus decreased inference performance (e.g., predictive accuracy) relative to inference performance on unmodified input data. Further techniques may be hardware-specific changes that impose power reductions in hardware at the expense of inference performance, or use smaller geometries for circuitry in hardware to allow for additional circuitry to be used at the same or a similar power budget. However, these techniques generally attempt to increase performance while keeping the input data in its original, raw format.

Aspects of the present disclosure provide techniques for reducing the computational cost of processing input data in machine learning models. As discussed in further detail herein, to reduce the computational complexity of processing a multidimensional input, layers in a machine learning model may be organized into a plurality of bins based on the magnitude of the largest outlier associated with each layer in the machine learning model, where the number of bins into which the layers are organized corresponds to a number of bits used for quantizing data. For a given layer of the machine learning model, a value previously stored in an accumulator of a MAC unit may be shifted based on a shift flag associated with that layer; where the shift flag is set to a binary high value (e.g., to 1), a shift may be performed on the value previously stored in the accumulator to effectuate a multiplication of the value by 2^{F}, where F corresponds to the number of bits by which the value stored in the accumulator is shifted. By using binary shifters in a MAC unit to shift values stored in an accumulator during operations involving a MAC unit, aspects of the present disclosure may allow for varying levels of quantization to be applied to various weights and/or activations in a machine learning model and may allow for efficient scaling of weights and/or activations. Thus, aspects of the present disclosure may allow for the use of smaller bit widths for quantizing data and reductions in the number of mathematical operations performed during operations using a machine learning model, which may allow for reductions in the computational expense involved in processing an input in a machine learning model, as data may be quantized using smaller and simpler data types (e.g., allowing data to be processed using 4-bit integer instead of larger integers or floating-point data). Thus, fewer compute resources may be utilized to complete various tasks for which transformer neural networks are used, such as object detection or other computer vision tasks. In turn, the techniques discussed herein may reduce the amount of power used by computing devices to perform these tasks and/or accelerate processing of multidimensional inputs, relative to the amount of power and/or time used when outliers are not attenuated in a transformer neural network.

### Example Quantization of Channels in a Machine Learning Model

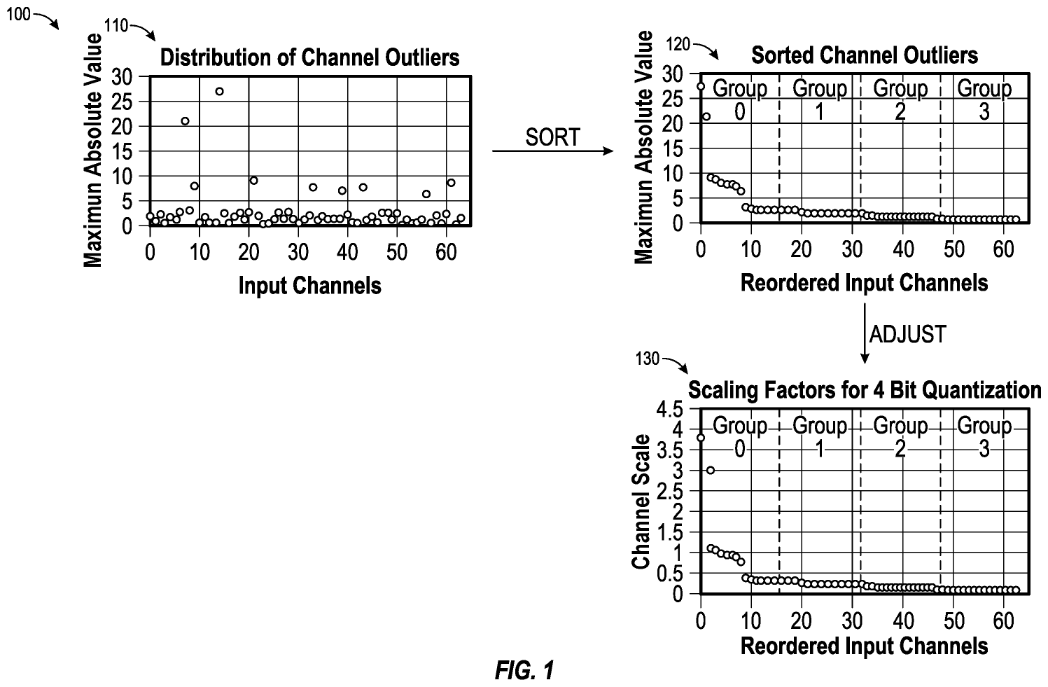

FIG. 1 illustrates an example 100 of quantization and sorting of quantized data channels associated with an input into a machine learning model based on maximum outlier values associated with each channel in the input into the machine learning model, according to aspects of the present disclosure

Generally, inputs into the machine learning model may include a plurality of data channels, with each data channel corresponding to different types of data. For example, channels in an input may include data in a height dimension, data in a width dimension, data in a depth dimension, or the like. In another example, channels in an input may include data in different color channels (e.g., red, green, and blue (RGB) channels, cyan, magenta, yellow, and black (CYMK) channels, video color channels (e.g., luminance (Y), blue difference (Pb), and red difference (Pr) channels in the YPbPr color space), etc.), (optionally) a transparency channel (also known as an alpha channel), and the like. As discussed, to determine how to quantize inputs into a machine learning model, the maximum absolute value of data in each of a plurality of channels in an input may be identified. This maximum absolute value for a channel may also be referred to as an outlier for the channel.

Based on the value of an outlier in each channel of the plurality of channels, an unsorted distribution 110 may be generated. As illustrated, channels associated with the input may, in an unsorted distribution 110, have a random distribution of outlier magnitude. Because of this random distribution, it may not be practical to support efficient runtime scaling and quantization of data using the unsorted distribution 110, as scaling between different channels in the unsorted distribution 110 may involve computationally expensive multiplication and division operations to move between different amounts of scaling for each channel.

Efficient scaling of data in a digital circuit may be effectuated by applying a binary shift to the data stored in the digital circuit. A leftward shift of n bits generally allows for a rapid upward scaling of data by a factor of 2ⁿ (i.e., according to the equation y=2ⁿx, where x corresponds to the original value stored in the digital circuit), while a rightward shift of n bits allows for a rapid downward scaling of data by a factor of 2ⁿ (i.e., according to the equation

$$y = \frac{1}{{2}^{n}} x ) .$$

A bitwise shift may thus effectuate a scaling of data in constant time (e.g., O(1) time), as opposed to multiplication operations that can be performed at a lower bound of O(n log n) time.

To allow for data to be rapidly scaled using binary shift operations, thus, the channel outliers illustrated in the unsorted distribution 110 may be sorted into the sorted channel outlier values 120. As illustrated, the sorted channel outliers may be grouped into a plurality of groups (also referred to as bins). Each of the groups may include an equal number of channels determined based on the total number of channels in the input and a number of processing elements across which execution of operations using the machine learning model can be distributed. By distributing the channels in the sorted channel outlier values 120 into a number of equally-sized bins, execution of operations using the machine learning model may be distributed in a balanced manner such that each processing element executes operations on a similar number of channels and no one processing element is tasked with executing operations with respect to a significantly different number of channels relative to the number of channels processed by other processing elements on which machine learning model operations are executed.

Outliers in each bin of channels may be quantized according to a defined bit width according to a scaling factor S defined for each channel. As discussed above, the scaling factor S may be represented by the equation:

$$S = \frac{max \{ \vert {r}_{min} \vert , \vert {r}_{max} \vert \}}{{2}^{b - 1} - 1} .$$

In the example illustrated in FIG. 1, the input includes sixty-four channels partitioned into four bins, labeled “Group 0,” “Group 1,” “Group 2,” and “Group 3.” Using the scaling factor S defined for each channel, it may be seen that the bin labeled “Group 0” includes two channels using a first scaling factor, six channels using a second scaling factor, one channel using a third scaling factor, and seven channels using a fourth scaling factor. All of the channels in the bin labeled “Group 1” use a fifth scaling factor. Fifteen channels in the bin labeled “Group 2” use a sixth scaling factor, with the remaining using a seventh scaling factor. Finally, seven channels in the bin labeled “Group 3” use the seventh scaling factor, seven channels use the eighth scaling factor, and the remaining two channels use an ninth scaling factor. The scaling factors may be a power of 2 to allow for binary bitwise shifting that efficiently allows for scaling of data channels and associated weights in a MAC unit used in processing these channels. For example, the first scaling factor, as illustrated, is a factor of roughly 4 (3.86); the second scaling factor is a factor of roughly 2 (1.93), the third scaling factor is a factor of roughly 1 (0.96), the fourth scaling factor is a factor of 0.5 (roughly 0.48), and so on.

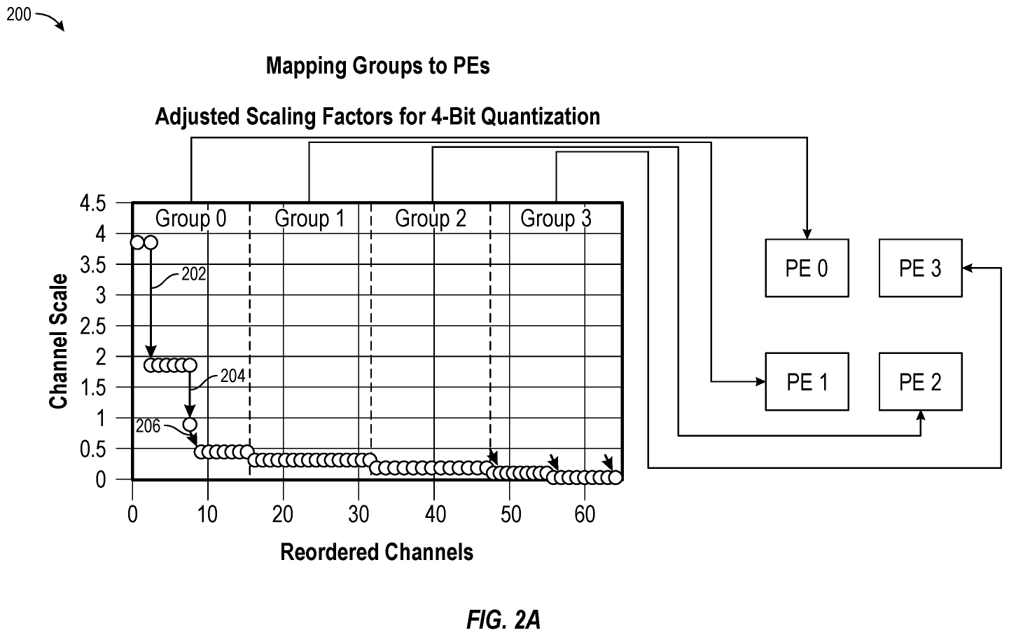

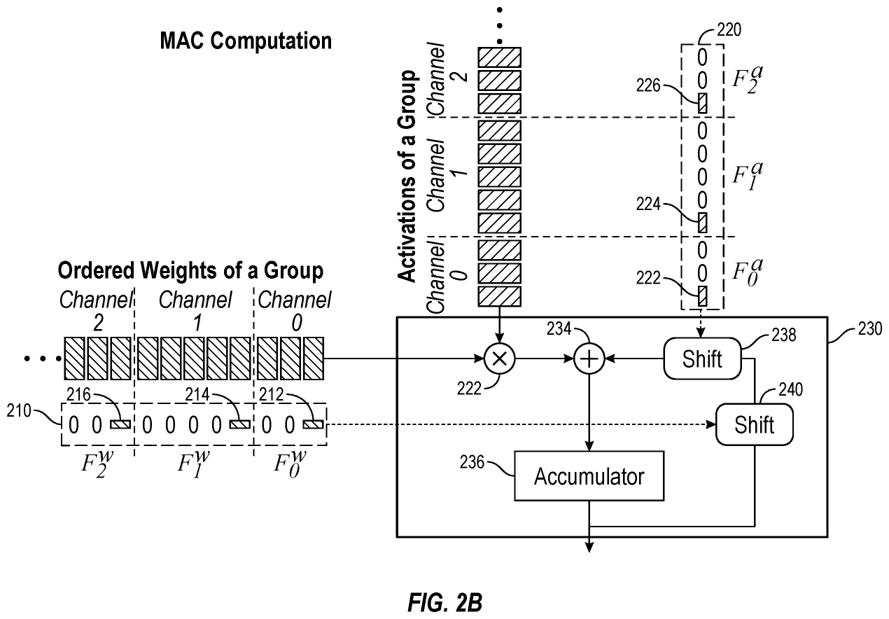

FIG. 2 illustrates an example multiply-and-accumulate (MAC) unit for efficiently processing inputs in a machine learning model, according to aspects of the present disclosure.

To efficiently allow for runtime scaling of input channels in machine learning model operations using a MAC unit, a base scaling factor Sg may be selected for each bin of the plurality of bins into which the channels are organized. As illustrated, thus, for the bin labeled “Group 0,” which may be assigned to a first processing element (PE) for processing, the minimum scaling factor may be set to the fourth scaling factor discussed above. Within the bin labeled “Group 0,” three shift points may be identified for scaling inputs: a first shift point 202, a second shift point 204, and a third shift point 206. The third shift point 206 indicates that the base scaling factor Sg is to be multiplied by 2, the second shift point 204 indicates that the scaling factor Sg is to be multiplied by 4 (or, correspondingly, that the scaling factor used after scaling at the third shift point 206 is to be multiplied by 2), and the first shift point 202 indicates that the scaling factor Sg is to be multiplied by 8 (or, correspondingly, that the scaling factor used after scaling at the second shift point 204 is to be multiplied by 2). To effectuate a shift, a weight shift array 210 associated with weights for the input channels for the bin labeled “Group 0” may be established. The array 210 generally includes a number of entries corresponding to the number of channels included in a bin (e.g., as discussed above, the total number of data channels in an input divided by the number of processing elements across which machine learning model operations are distributed), and each channel may be associated with a binary flag. If a leftwards shift is to be performed on an input, weights, and/or previously accumulated data, the flag corresponding to a data channel may be set to a high value; otherwise, the flag corresponding to that data channel may be set to a low value.

Each processing element used in performing machine learning model operations may include one or more MAC units 230 which execute multiply-and-accumulate operations on weight inputs and activation inputs fed into the MAC unit 230. As illustrated, a MAC unit 230 includes a multiplier block 232, an addition block 234, an accumulator 236, an activation shifter 238, and a weight shifter 240. Each data channel may be associated with one or more weights with corresponding weight shift flags and one or more activations with corresponding activation shift flags. For example, as illustrated, a first channel may be associated with a first weight shift flag 212 and a first activation shift flag 222; a second channel may be associated with a second weight shift flag 214 and a second activation shift flag 224; a third channel may be associated with a third weight shift flag 216 and a third activation shift flag 226; and so on.

The weight shift flags Fᵢ^{w} 212, 214, 216 may be included in a weight shift array 210 input into the weight shifter 240, and the activation shift flags Fᵢ^{a} 222, 224, 226 may be included in an activation shift array 220 input into the activation shifter 238, for the i^{th} channel in the group. During operations, a first activation input and a first weight may be input into the multiplier block 232 to generate a product of the first activation input and the first weight (and, in some aspects, the base scaling factor associated with the bin (or group) of channels for which the MAC unit 230 is used for processing). Generally, activation inputs and weights may be input into the MAC unit 230 for processing based on the ordered weights associated with different channels in the bin (or group) of channels for which the MAC unit 230 is used for processing such that the activation shifter 238 and the weight shifter 240 are configured to perform left shifts to scale data by a factor of 2ⁿ, where n corresponds to a number of bits by which data is to be scaled, and need not perform right shifts to scale data by a factor of 1/2ⁿ.

Data included in the accumulator 236 may be shifted by the weight shifter 240 and the activation shifter 238 prior to being fed into the addition block 234 for combination with the output of the multiplier block 232. The data in the accumulator may be shifted according to a number of bits identified by the first weight shift flag 212 at the weight shifter 240 and a number of bits identified by the first activation shift flag 222 at the activation shifter 228. If F₀^{W}=0 and F₀^{a}å=0, no shift may be performed for data in channel 0 (the first channel in the bin (or group) of channels), and the data in the accumulator 236 may be fed into the addition block 234 without modification. Otherwise, the data in the accumulator 236 may be shifted by the number of bits identified by the first weight shift flag 212 and the first activation shift flag 222 using the weight shifter 240 and the activation shifter 238, respectively.

Subsequent weights and activations for channel 0 may be processed through the MAC unit 230, with no further modifications being performed on the data in the accumulator 236, as the weight shifter 240 and the activation shifter 238 may receive as input values of 0 from the weight shift array 210 and activation shift array 220 for the corresponding weights and activations.

When operations are performed in respect of channel 1, the second weight shift flag 214 and the second activation shift flag 224 may be fed into the weight shifter 240 and the activation shifter 238, respectively, for use in applying a binary shift to the data stored in the accumulator prior to combining the shifted data with the product of the first weight and activation associated with channel 1. Similarly, when operations are performed in respect of channel 2, as illustrated, the third weight shift flag 216 and the third activation shift flag 226 may be used by the weight shifter 240 and the activation shifter 238, respectively, for use in applying a binary shift to the data stored in the accumulator prior to combining the shifted data with the product of the first weight and activation associated with channel 2. The shifting of data in the accumulator 236 may continue for each channel in the bin (group) of channels for which the MAC unit 230 is used for processing until each of the channels in the bin have been processed.

### Example Operations for Efficient Processing of Inputs in a Machine Learning Model Based on Shifts Applied to Data in a Multiply-and-Accumulate (MAC) Unit

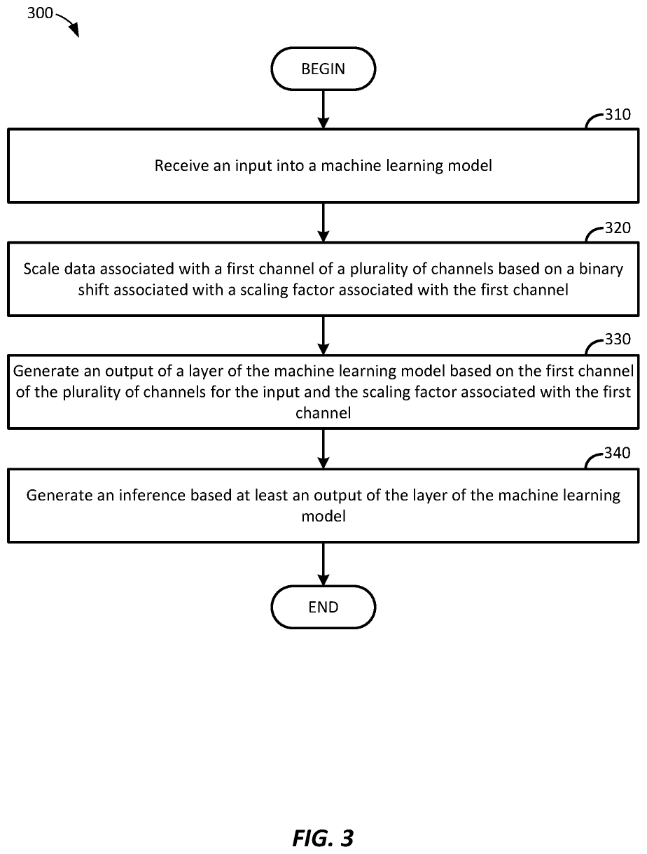

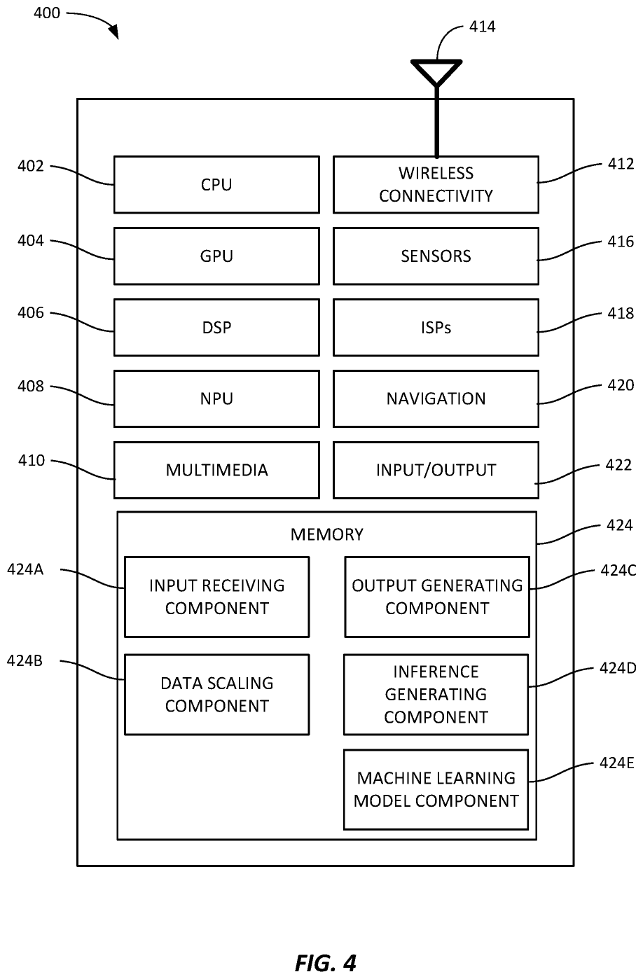

FIG. 3 illustrates example operations 300 for efficiently processing inputs in a machine learning model based on binary shifts associated with outlier magnitude for channels associated with an input into a machine learning model, according to aspects of the present disclosure. The operations 300 may be performed, for example, by a computing system on which a machine learning model is deployed, such as one or more processors including one or more MAC units (e.g., the MAC unit 230 illustrated in FIG. 2), such as a user equipment (UE), a smartphone, a tablet computer, an autonomous vehicle, an edge device, or other computing system (e.g., such as processing system 400 illustrated in FIG. 4 and described in further detail below).

As illustrated, the operations 300 begin at block 310, with receiving an input into a machine learning model. Generally, the input includes a plurality of channels, and each channel is associated with a respective scaling factor. In some aspects, the respective scaling factor may include a weight scaling factor and an activation scaling factor. The scaling factor may be applied, for example, to a minimum scaling factor identified for a group of data channels assigned to one of a plurality of bins. In some aspects, the scaling factor may identify a number of bits to be used in shifting data in a MAC unit. As discussed, a shift of n bits (where positive values of n are associated with a shift leftwards and negative values of n are associated with a shift rightwards) identified by the scaling factor may effectively result in the multiplication of data to which the shift is applied by 2ⁿ with a computational expense of O(1), representing a significant decrease in computational expensive relative to other multiplication techniques which may incur a computational expense that scales with the length of the data to be multiplied.

At block 320, the operations 300 proceed with scaling data associated with a first channel of the plurality of channels based on a binary shift associated with a scaling factor associated with the first channel.

At block 330, the operations 300 proceed with generating an output of a layer in the machine learning model based on the first channel of the plurality of channels for the input and the scaling factor associated with the first channel.

At block 340, the operations 300 proceed with generating an inference based at least on the output of the layer in the machine learning model.

In some aspects, the plurality of channels are organized into a plurality of bins based on an outlier value for each channel of the plurality of channels.

In some aspects, a shift value associated with each respective channel in a bin from the plurality of bins is based on a maximum scaling factor for a channel in the bin calculated based on a maximum outlier value and a minimum outlier value associated with channels in the bin and a number of bits used to quantize data in the machine learning model.

In some aspects, the shift value associated with each respective channel in the bin is based on a power-of-two adjustment relative to a minimum defined scaling factor for channels in the bin. Within the bin, thus, the shift value, which identifies a number of bits by which data in an accumulator is to be shifted prior to being added to the product of a weight and an activation input for a data channel input into the MAC unit.

In some aspects, each bin of the plurality of bins is associated with a shifting map identifying channels within the bin at which a shift operation is to be performed relative to a minimum scaling factor defined for a channel in the bin. The shifting map may, in some aspects, be a binary map, where a high value indicates that a one-bit left shift is to be applied to data in an accumulator and a low value indicates that no shift is to be applied. In some aspects, the shifting map may be an array including elements for each data element associated with a channel of the channels in the bin. The first element associated with a new channel may include a shift value F identifying the number of bits by which the data in the accumulator is to be shifted. In some aspects, the shift value F may range from 0 (indicating that no shift is to be applied) to any positive number (indicating that a shift corresponding to multiplication of the data in the accumulator by 2^{F} is to be applied).

### Example Processing System for Efficient Processing of Inputs in a Machine Learning Model Based on Shifts Applied to Data in a Multiply-and-Accumulate (MAC) Unit

FIG. 4 depicts an example processing system 400 configured to perform various aspects of the present disclosure, including, for example, the techniques and methods described with respect to FIGS. 1-3. Although depicted as a single system for conceptual clarity, in at least some aspects, as discussed above, the operations described below with respect to the processing system 400 may be distributed across any number of devices.

The processing system 400 includes a central processing unit (CPU) 402, which in some examples may be a multi −∞ re CPU. Instructions executed at the CPU 402 may be loaded, for example, from a program memory associated with the CPU 402 or may be loaded from a partition of memory 424.

The processing system 400 also includes additional processing components tailored to specific functions, such as a graphics processing unit (GPU) 404, a digital signal processor (DSP) 406, a neural processing unit (NPU) 408, a multimedia processing unit 410, and a wireless connectivity component 412.

An NPU, such as NPU 408, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 408, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 408 is a part of one or more of the CPU 402, the GPU 404, and/or the DSP 406.

In some examples, the wireless connectivity component 412 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 412 is further coupled to one or more antennas 414.

The processing system 400 may also include one or more sensor processing units 416 associated with any manner of sensor, one or more image signal processors (ISPs) 418 associated with any manner of image sensor, and/or a navigation component 420, which may include satellite-based positioning system components (e.g., GPS or GLONASS) as well as inertial positioning system components.

The processing system 400 may also include one or more input and/or output devices 422, such as screens, touch-sensitive surfaces (including touch-sensitive displays), physical buttons, speakers, microphones, and the like.

In some examples, one or more of the processors of the processing system 400 may be based on an ARM or RISC-V instruction set.

In some examples, one or more of the processors of the processing system 400 may include one or more MAC units, such as that illustrated in FIG. 2, which can be used to efficiently process inputs into a machine learning model based on binary shifts applied to a base scaling factor associated with data channels processed by a MAC unit.

The processing system 400 also includes the memory 424, which is representative of one or more static and/or dynamic memories, such as a dynamic random access memory, a flash-based static memory, and the like. In this example, the memory 424 includes computer-executable components, which may be executed by one or more of the aforementioned processors of the processing system 400.

In particular, in this example, the memory 424 includes an input receiving component 424A, a data scaling component 424B, an output generating component 424C, an inference generating component 424D, and a machine learning model 424E. Though depicted as discrete components for conceptual clarity in FIG. 4, the illustrated components (and others not depicted) may be collectively or individually implemented in various aspects.

Generally, the processing system 400 and/or components thereof may be configured to perform the methods described herein.

Notably, in other aspects, aspects of the processing system 400 may be omitted, such as where the processing system 400 is a server computer or the like. For example, the multimedia processing unit 410, the wireless connectivity component 412, the sensor processing units 416, the ISPs 418, and/or the navigation component 420 may be omitted in other aspects. Further, aspects of the processing system 400 may be distributed between multiple devices.

### Example Clauses

Implementation details of various aspects of the present disclosure are described in the following numbered clauses:

Clause 1: A processor-implemented method for executing machine learning model operations, comprising: receiving an input into a machine learning model, the input including a plurality of channels, each respective channel being associated with a respective scaling factor; scaling data associated with a first channel of the plurality of channels, based on a binary shift associated with a scaling factor associated with the first channel; generating an output of a layer of the machine learning model based on the first channel of the plurality of channels for the input and the scaling factor associated with the first channel; and generating an inference based at least on the output of the layer of the machine learning model.

Clause 2: The method of Clause 1, wherein the respective scaling factor associated with the respective channel comprises a weight scaling factor and an activation scaling factor.

Clause 3: The method of Clause 1 or 2, wherein the plurality of channels are organized into a plurality of bins based on an outlier value for each channel of the plurality of channels.

Clause 4: The method of Clause 3, wherein a shift value associated with each respective channel in a bin from the plurality of bins is based on a maximum scaling factor for a channel in the bin calculated based on a maximum outlier value and a minimum outlier value associated with channels in the bin and a number of bits used to quantize data in the machine learning model.

Clause 5: The method of Clause 4, wherein the shift value associated with each respective channel in the bin is further based on a power-of-two adjustment.

Clause 6: The method of any of Clauses 3 through 5, wherein each bin of the plurality of bins is associated with a shifting map identifying channel within the bin at which a shift operation is to be performed relative to a minimum scaling factor defined for a channel in the bin.

Clause 7: The method of any of Clauses 1 through 6, wherein the respective scaling factor associated with each respective channel of the plurality of channels comprises a value calculated based on a representative set of input data for the machine learning model.

Clause 8: A multiply-and-accumulate (MAC) unit for efficient processing of inputs in a machine learning model, comprising: a multiplier configured to generate a product of a weight input and an activation input associated with a channel of an input into the machine learning model; one or more shifters configured to generated a scaled accumulator value based on applying a binary shift to accumulator data based on a binary shift associated with a scaling factor defined for the channel; an adder configured to generate a sum of the product of the weight input and the activation input associated with the channel and the scaled accumulator value; and an accumulator configured to store, as the accumulator data, the sum of the product of the weight input and the activation input associated with the channel and the scaled accumulator value.

Clause 9: The MAC unit of Clause 8, wherein the one or more shifters comprise a weight shifter and an activation shifter.

Clause 10: The MAC unit of Clause 9, wherein the one or more shifters are configured to apply a first binary shift to the accumulator data based on a first number of bits defined for a weight shift value for the channel and a second binary shift to the accumulator data based on a second number of bits defined for an activation shift value for the channel.

Clause 11: The MAC unit of any of Clauses 8 through 10, wherein the weight input comprises a weight array including weights for one or more channels including the channel, and wherein the activation input comprises an activation data array including activation data for one or more channels including the channel.

Clause 12: The MAC unit of Clause 11, wherein the scaling factor defined for the channel comprises a weight shift flag array corresponding to the weight array and an activation shift flag array corresponding to the activation data array.

Clause 13: The MAC unit of Clause 11 or 12, wherein the weight array and the activation data array comprise binary flag arrays, wherein a high value corresponds to a one-bit leftward shift to be applied to the accumulator data and a low value corresponds to no shift to be applied to the accumulator data.

Clause 14: The MAC unit of any of Clauses 11 through 13, wherein the weight array and the activation data array comprise integer arrays including a plurality of entries, each entry identifying a number of bits to use in leftward shifting the accumulator data.

Clause 15: A processing system comprising: a memory comprising computer-executable instructions; and one or more processors configured to execute the computer-executable instructions and cause the processing system to perform a method in accordance with any of Clauses 1-7.

Clause 16: A processing system comprising means for performing a method in accordance with any of Clauses 1-7.

Clause 17: A non-transitory computer-readable medium comprising computer-executable instructions that, when executed by one or more processors of a processing system, cause the processing system to perform a method in accordance with any of Clauses 1-7.

Clause 18: A computer program product embodied on a computer-readable storage medium comprising code for performing a method in accordance with any of Clauses 1-7.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method for executing machine learning model operations, comprising:
receiving an input into a machine learning model, the input including a plurality of channels, each respective channel being associated with a respective scaling factor;
scaling data associated with a first channel of the plurality of channels, based on a binary shift associated with a scaling factor associated with the first channel;
generating an output of a layer of the machine learning model based on the first channel of the plurality of channels for the input and the scaling factor associated with the first channel; and
generating an inference based at least on the output of the layer of the machine learning model.

2. The method of claim 1, wherein the respective scaling factor associated with the respective channel comprises a weight scaling factor and an activation scaling factor.

3. The method of claim 1, wherein the plurality of channels are organized into a plurality of bins based on an outlier value for each channel of the plurality of channels.

4. The method of claim 3, wherein a shift value associated with each respective channel in a bin from the plurality of bins is based on a maximum scaling factor for a channel in the bin calculated based on a maximum outlier value and a minimum outlier value associated with channels in the bin and a number of bits used to quantize data in the machine learning model.

5. The method of claim 4, wherein the shift value associated with each respective channel in the bin is further based on a power-of-two adjustment.

6. The method of claim 3, wherein each bin of the plurality of bins is associated with a shifting map identifying channel within the bin at which a shift operation is to be performed relative to a minimum scaling factor defined for a channel in the bin.

7. The method of claim 1, wherein the respective scaling factor associated with each respective channel of the plurality of channels comprises a value calculated based on a representative set of input data for the machine learning model.

8. A multiply-and-accumulate (MAC) unit for efficient processing of inputs in a machine learning model, comprising:
a multiplier configured to generate a product of a weight input and an activation input associated with a channel of an input into the machine learning model;
one or more shifters configured to generated a scaled accumulator value based on applying a binary shift to accumulator data based on a binary shift associated with a scaling factor defined for the channel;
an adder configured to generate a sum of the product of the weight input and the activation input associated with the channel and the scaled accumulator value; and
an accumulator configured to store, as the accumulator data, the sum of the product of the weight input and the activation input associated with the channel and the scaled accumulator value.

9. The MAC unit of claim 8, wherein the one or more shifters comprise a weight shifter and an activation shifter.

10. The MAC unit of claim 9, wherein the one or more shifters are configured to apply a first binary shift to the accumulator data based on a first number of bits defined for a weight shift value for the channel and a second binary shift to the accumulator data based on a second number of bits defined for an activation shift value for the channel.

11. The MAC unit of claim 8, wherein the weight input comprises a weight array including weights for one or more channels including the channel, and wherein the activation input comprises an activation data array including activation data for one or more channels including the channel.

12. The MAC unit of claim 11, wherein the scaling factor defined for the channel comprises a weight shift flag array corresponding to the weight array and an activation shift flag array corresponding to the activation data array.

13. The MAC unit of claim 11, wherein the weight array and the activation data array comprise binary flag arrays, wherein a high value corresponds to a one-bit leftward shift to be applied to the accumulator data and a low value corresponds to no shift to be applied to the accumulator data.

14. The MAC unit of claim 11, wherein the weight array and the activation data array comprise integer arrays including a plurality of entries, each entry identifying a number of bits to use in leftward shifting the accumulator data.

15. An apparatus for executing machine learning model operations, comprising:
means for receiving an input into a machine learning model, the input including a plurality of channels, each respective channel being associated with a respective scaling factor;
means for scaling data associated with a first channel of the plurality of channels, based on a binary shift associated with a scaling factor associated with the first channel;
means for generating an output of a layer of the machine learning model based on the first channel of the plurality of channels for the input and the scaling factor associated with the first channel; and
means for generating an inference based at least on the output of the layer of the machine learning model.

16. The apparatus of claim 15, wherein the respective scaling factor associated with the respective channel comprises a weight scaling factor and an activation scaling factor.

17. The apparatus of claim 15, wherein the plurality of channels are organized into a plurality of bins based on an outlier value for each channel of the plurality of channels.

18. The apparatus of claim 17, wherein a shift value associated with each respective channel in a bin from the plurality of bins is based on a maximum scaling factor for a channel in the bin calculated based on a maximum outlier value and a minimum outlier value associated with channels in the bin and a number of bits used to quantize data in the machine learning model.

19. The apparatus of claim 17, wherein each bin of the plurality of bins is associated with a shifting map identifying channel within the bin at which a shift operation is to be performed relative to a minimum scaling factor defined for a channel in the bin.

20. The apparatus of claim 15, wherein the respective scaling factor associated with each respective channel of the plurality of channels comprises a value calculated based on a representative set of input data for the machine learning model.
